(19) United States
(12) Patent Application Publication
(10) Pub. No.: US 2016/0269790 A1
(43) Pub. Date: Sep. 15, 2016

(54) MANAGEMENT METHOD, MANAGEMENT DEVICE AND NON-TRANSITORY COMPUTER-READABLE STORAGE MEDIUM FOR TELEVISION PROGRAM INFORMATION SHARING NETWORK

(71) Applicant: MStar Semiconductor, Inc., Hsinchu Hsien (TW)

(72) Inventor: Sung-Wen Wang, Zhubei City (TW)

(21) Appl. No.: 14/722,312

(22) Filed: May 27, 2015

(30) Foreign Application Priority Data
Mar. 10, 2015 (TW) 104107582

(51) Int. Cl. H04N 21/4788

(52) U.S. Cl. CPC H04N 21/4788

(57) ABSTRACT

A management method for sharing television program information is provided. The method includes: receiving a first sharing request for sharing a first television program with a first receiver account in a first social network, and a second sharing request for sharing a second television program with a second receiver account in a second social network; according to whether the first television program and the second television program are the same, and whether the first receiver account and the second receiver account correspond to a same user, selectively merging the first sharing request and the second sharing request.

This application claims the benefit of Taiwan application Serial No. 104107582, filed Mar. 10, 2015, the subject matter of which is incorporated herein by reference.

### BACKGROUND OF THE INVENTION

1. Field of the Invention

The invention relates in general to a television device, and more particularly to a management technology that shares television program information through a network.

2. Description of the Related Art

Televisions are essential, indispensible devices in most households. Many television devices are capable of transceiving information through the Internet. For example, when a user reckons that a television program being watched is highly recommendable, there are currently technologies that allow the user to share related information of the television program through the Internet in real-time to friends in the user's social network.

It should be noted that, many people own accounts of more than one social network. In other words, a user account A₁ in a first social network and a user account A₂ in a second social network may belong to the same user A. Assume that a friend, a user B, of the user A also owns accounts of the first social network and the second social network. When the user B shares much liked television program information with all friends in the first social network and the second social network, the user A receives recommended information sent to both the user account A₁ and the user account A₂. Such situation of repeatedly receiving the same information may cause complications for the user receiving the recommended information.

### SUMMARY OF THE INVENTION

To solve the above issue, the present invention provides a management method, a management device and a non-transitory computer-readable storage medium that appropriately merge similar or the same television program information sharing requests.

According to an embodiment of the present invention, a management method for sharing television program information is provided. The method includes steps of: receiving a first sharing request for sharing a first television program with a first receiver account in a first social network, and a second sharing request for sharing a second television program with a second receiver account in a second social network; according to whether the first television program and the second television program are the same, and whether the first receiver account and the second receiver account both correspond to a receiving user, selectively merging the first sharing request and the second sharing request.

According to another embodiment of the present invention, a management device for sharing television program information is provided. The device includes a database, a receiving module, a first determining module, a second determining module and a merging module. The database records a plurality of account/user correspondence relationships. The receiving module receives a first sharing request for sharing a first television program with a first receiver account in a first social network, and a second sharing request for sharing a second television program with a second receiver account in a second social network. The first determining module determines whether the first television program and the second television program are the same. The second determining module determines whether the first receiver account and the second receiver account both correspond to a receiver user through looking up the database. According to determination results of the first determining module and the second determining module, the merging module selectively merges the first sharing request and the second sharing request.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) and FIG. 1(B) are functional block diagrams of a management device according to an embodiment of the present invention;

FIG. 2(A) and FIG. 2(B) are examples of architecture capable of realizing a television program information sharing network; and

FIG. 3, FIG. 4(A) and FIG. 4(B) are flowcharts of a management method according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes need not be achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

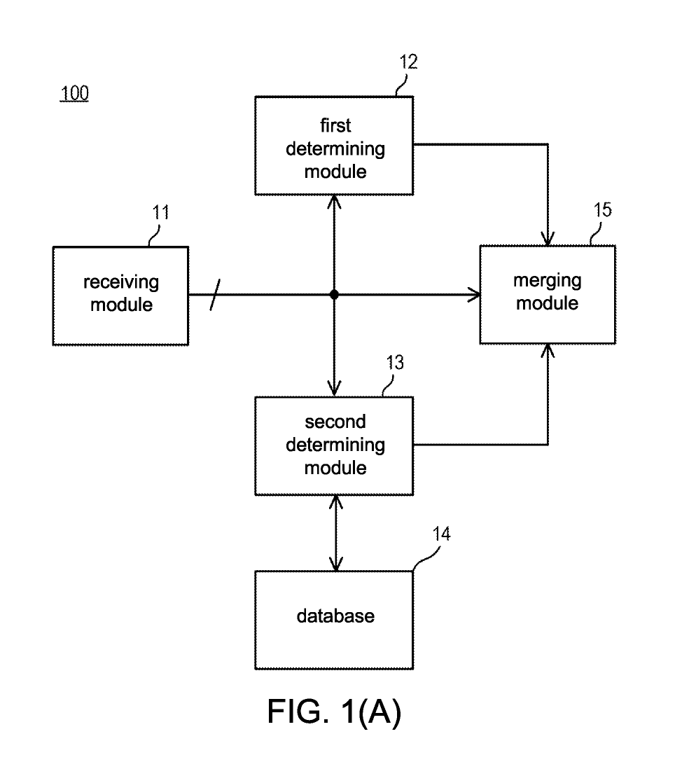

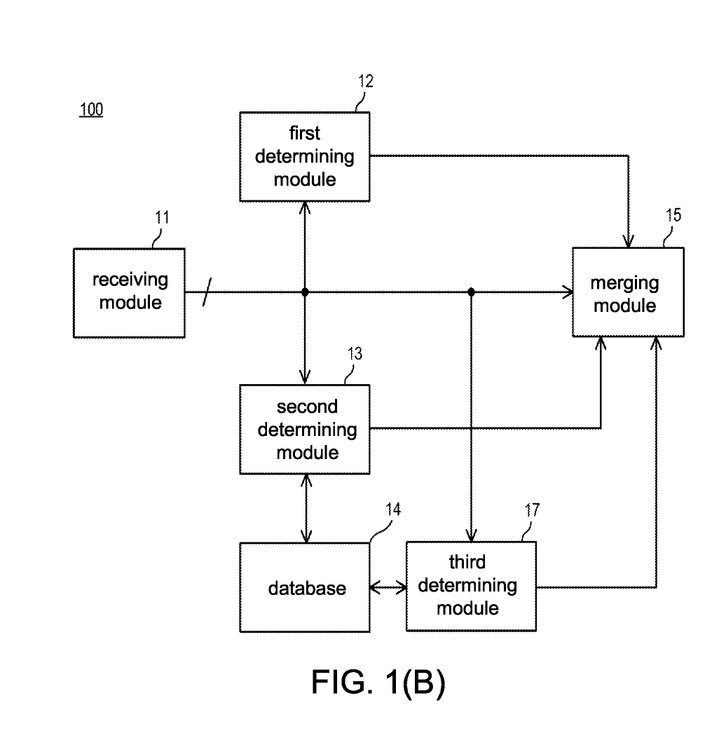

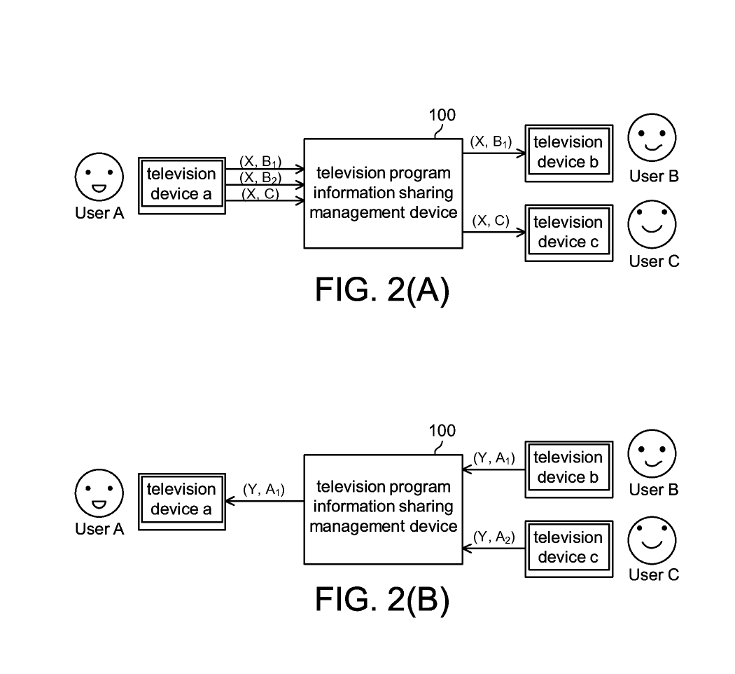

A management device for sharing television program information is provided according to an embodiment of the present invention. FIG. 1(A) shows a functional block diagram of the management device. A management device 100 includes a receiving module 11, a first determining module 12, a second determining module 13, a database 14 and a merging module 15. FIG. 2(A) and FIG. 2(B) show examples of architecture of a television program information sharing network capable of realizing the concept of the present invention. In the example, television devices (television devices a, b and c) owned by three different users (users A, B and C) are connected to the management device 100. In practice, the management device 100 may be connected to the television devices through the Internet or local area network (LAN). In one embodiment, the receiving module 11 may be a wired or wireless network signal receiving port. The management device 100 may be, but not limited to, a cloud device provided by a network service provider. For example, functions of the management device 100 may also be distributed in multiple hardware devices (e.g., multiple television devices) of a distributed system. One person skilled in the art can understand that, the number of television devices connected to the management device 100 is not limited to those shown in FIG. 2(A) and FIG. 2(B). It should be noted that, technical details of information transmission among one management device and multiple television devices are known to one person skill in the art, and shall be omitted herein. Further, the so-called television devices cover all kinds of devices with capabilities for receiving analog, digital and/or network television program signals, e.g., set-up boxes (STBs), over-the-top (OTP) televisions, mobile communication devices and personal computers.

The database 14 records a plurality of account/user corresponding relationships. For example, to use a “blocking repeated television program sharing information” service that the management device 100 provides, the user B may register at the management device 100 to inform the management device 100 that, a first account B₁ in a first social network and a second account B₂ in a second social network B both belong to the user B. Alternatively, when the user B does not wish to repeatedly transmit the television program sharing information that he/she transmits to multiple accounts in different social networks of his/her friends, the user A may also register at the management device 100 in advance to inform the management device 100 that, the first account B₁ in the first social network and the second account B₂ in the second social network correspond to the same user B. In practice, the management device 100 may receive an account registration request from a user or a social network provider, and modify contents in the database according to the account registration request. The scope of the present invention is not limited to a specific storage mechanism. The database 14 may be stored in one or multiple volatile or non-volatile memory devices, e.g., random access semiconductor memories, read-only memories, magnetic and/or optical memories, and flash memories.

According to an embodiment of the present invention, the television program sharing information transmitted among the television devices a, b and c is first provided to the receiving module 11 in the management device 100 in form of a sharing request. A plurality sharing requests that the receiving module 11 receives within a period may be sent from one single user, or may be from multiple different users. Each sharing request corresponds to one television program and one account registered in a social network. In the example shown in FIG. 2(A), the user A transmits three sharing requests to the management device 100. Among the three sharing requests, one is for sharing information of a television program X with the account B₁ registered in the first social network, another is for sharing the information of the television program X with the account B₂ registered in the second social network, and the other is for sharing the information of the television program X with an account C registered in the second social network. In the example shown in FIG. 2(B), the user B transmits a sharing request to the management device 100 to request sharing information of a television program Y with the account A₁ registered in the first social network (corresponding to the user A), and a user C also transmits a sharing request to the management device 100 to request sharing the information of the television program Y with the account A₂ registered in the second social network (corresponding to the user A).

In practice, the receiving module 11 may be configured to wait for a predetermined period after receiving one sharing request to see if there are other sharing requests that subsequently arrive, and then request the first determining module 12 and the second determining module 13 to start operating. For example, the predetermined period may be 1 to 10 minutes or 1 to 6 hours.

In one example, the plurality of sharing requests received by the receiving module 11 include a first sharing request and a second sharing request. The first sharing request requests sharing a first television program with a first receiver account in a first social network, and the second sharing request requests sharing a second television program with a second receiver account in a second social network. The first determining module 12 determines whether the first television program and the second television program are the same. The second determining module 13 determines whether the first receiver account and the second receiver account both correspond to a receiving user through looking up the database 14. When the determination results of both the first determining module 12 and the second determining module 13 are affirmative, the merging module 15 merges the first sharing request and the second sharing request into a merged sharing request. In practice, the first determining module 12 and the second determining module 13 may determine one after another whether the plurality of sharing requests include sharing requests to be merged.

In the situation shown in FIG. 2(A), the first determining module 12 discovers that the three sharing requests that the receiving module 111 receives correspond to the same television program X. On the other hand, the second determining module 13 discovers that the first two sharing requests both correspond to the same user B. Thus, the merging module 15 merges these two repeated sharing requests into a merged sharing request, and transmits the merged sharing request to the user B. Further, the merging module 15 also transmits the non-repeated sharing request to the user C. It is known from the above description that, even when the user A transmits sharing requests to both the account B₁ and the account B₂, the user B only receives one single set of shared information to assist the user B in preventing from receiving repeated messages.

In the situation shown in FIG. 2(B), the first determining module 12 discovers that the two sharing requests that the receiving module 11 receives correspond to the same television program Y. On the other hand, the second determining module 13 discovers that these two sharing requests both correspond to the same user A. Thus, the merging module 15 also merges these two repeated requests into a merged sharing request, and transmits the merged sharing request to the user A. It is obvious that the user A also receives one single set of sharing information.

In another example, the first sharing request is sent from a first transmitter account in the first social network, and the second sharing request is sent from a second transmitter account in the second social network. As shown in FIG. 1(B), the management device 100 may further include a third determining module 17 that determines whether the first transmitter account and the second transmitter account both correspond to a transmitting user. In the embodiment, the merging module 15 determines whether to include user information of the first transmitter account and the second transmitter account in the merged sharing request according to the determination result of the third determining module 17. For example, the merging module 15 may specify a message in the merged sharing request to be sent to the user A that, the user B and the user C wish to share the television program Y with the user A. In practice, similar to the second determining module 13, the third determining module 17 may utilize the information in the database 14 as the determination basis.

In practice, the first determining module 12, the second determining module 13 and the third determining module 17 may be implemented by multiple control and processing platforms, including fixed and programmable logic circuits, e.g., programmable logic gate arrays, application-specific integrated circuits, microcontrollers, microprocessors, and digital signal processors. Further, the first determining module 12, the second determining module 13 and the third determining module 17 may be designed to complete respective tasks through executing processor commands stored in a memory.

Further, there are many scenarios according to which the first determining module 12 determines whether the two sharing requests correspond to the same television program. In one embodiment, each sharing request provided to the receiving module 11 includes one or multiple sets of program information including the channel name, program name, program time, program synopsis, program snapshot and cast list. For example, the first determining module 12 may be configured to determine whether the two sharing requests correspond to the same television program according to two conditions of the program name and the cast list. In other words, given the program name and the cast list are the same, the first determining module 12 regards these two sharing requests as corresponding to the same television program.

According to sources of program contents, current television systems are mainly divided into three television system types—digital television systems, analog television systems and network television systems. The program information of the digital television system is usually recorded in an electronic program guide (EPG). The program information of the analog television system is obtained from data provided by the service provider. The program information of the network television system may be queried from a communication service provider (CSP) database. A television device transmitting a sharing request may obtain the program information from the several data sources above, and include the program information in the sharing request to be transmitted the management device 100. Alternatively, if the program information included in the sharing request is not enough, the first determining module 12 of the management device 100 may initiatively retrieve more program information from the several data sources above.

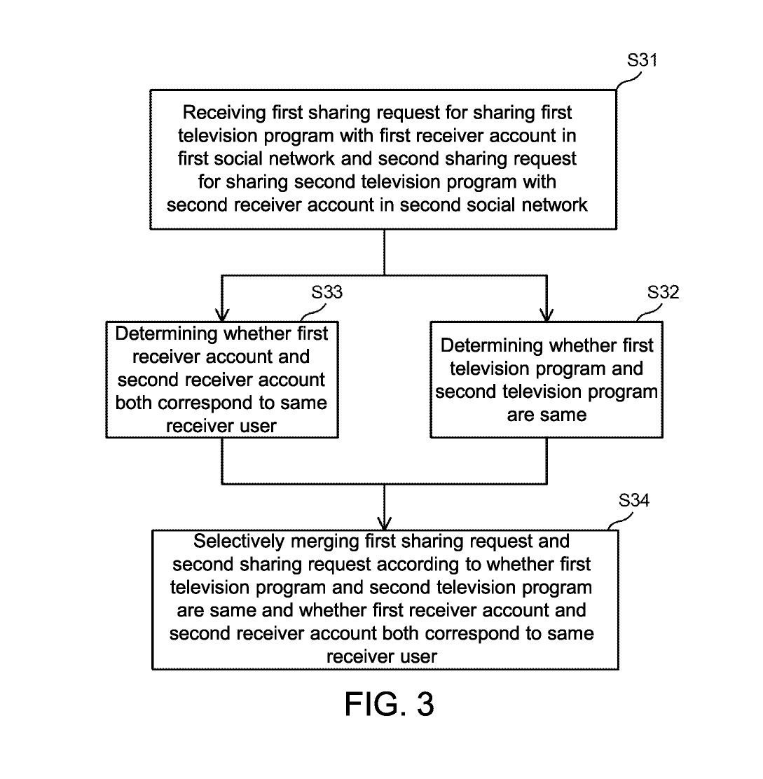

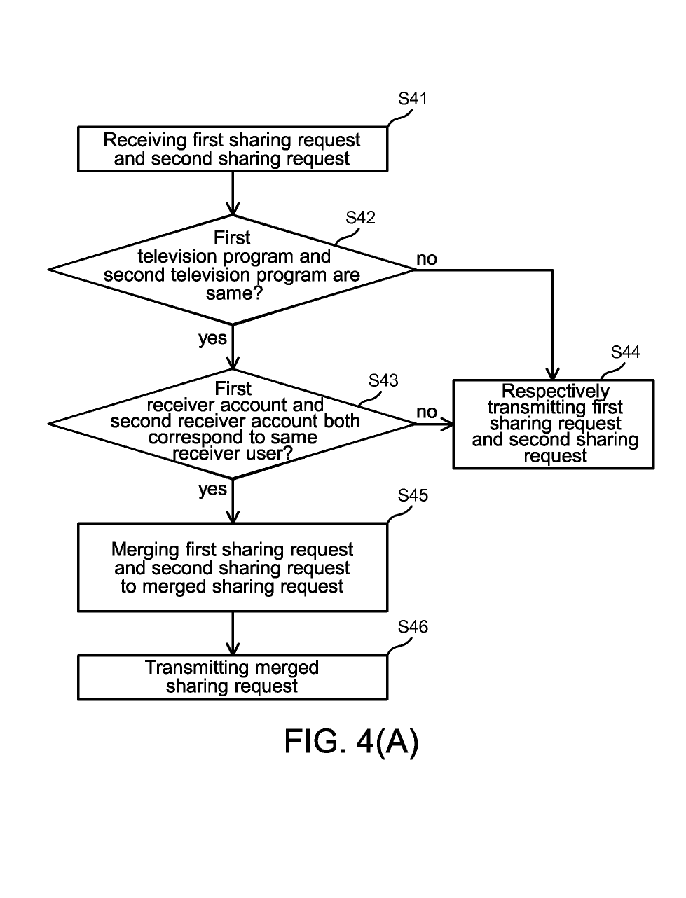

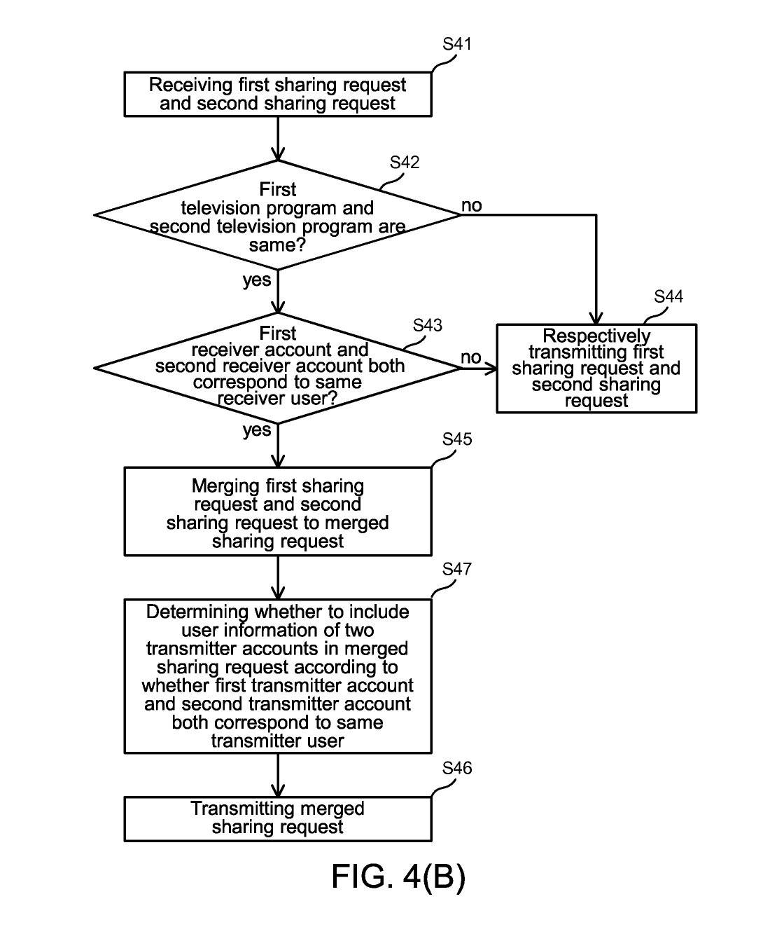

A management method for a television program information sharing network is provided according to another embodiment of the present invention. FIG. 3 shows a flowchart of the management method. In step S31, a first sharing request for sharing a first television program with a first receiver account in a first social network, and a second sharing request for sharing a second television program with a second receiver account in a second social network are received. In step S32, it is determined whether the first television program and the second television program are the same. In step S33, it is determined whether the first receiver account and the second receiver account both correspond to a receiving user. In step S34, according to determination results of step S32 and step S33, the first sharing request and the second sharing request are selectively merged.

FIG. 4(A) shows detailed steps of the above management method. In step S41, a first sharing request and a second sharing request are received. The first sharing request requests sharing a first television program with a first receiver account in a first social network. The second sharing request requests sharing a second television program with a second receiver account in a second social network. In step S42, it is determined whether the first television program and the second television program are the same. In step S43, it is determined whether the first receiver account and the second receiver account both correspond to a receiving user. When determination results of both steps S42 and S43 are affirmative, the first sharing request and the second sharing request are merged to a merged sharing request in step S45. In step S46, the merged sharing request is transmitted. In contrast, when one of the determination results of steps S42 and S43 is negative, step S44 is performed. That is, in step S44, the merging process is not performed, and the first sharing request and the second sharing request are respectively transmitted.

One person skilled in the art can understand that, orders for performing steps S42 and S43 can be swapped or steps S42 and S43 may be simultaneously performed, and an overall effect of the management method is unaffected. Further, operation variations given in the description associated with the management device 100 may be applied to the management method in FIG. 3 and FIG. 4(A). For example, as shown in FIG. 4(B), a step S47 may be added between step S45 and step S46. In step S47, according to a determination result of whether a first transmitter account and a second transmitter account both correspond to a transmitting user, it is determined whether to include user information of the first transmitter account and the second transmitter account in the merged sharing request.

A non-transitory computer-readable storage medium is further provided according to another embodiment of the present invention. The non-transitory computer-readable storage medium stores a code readable and executable by a processor. The code includes multiple sub-codes. A first sub-code is for receiving a first sharing request for sharing a first television program with a first receiver account in a first social network, and a second sharing request for sharing a second television program with a second receiver account in a second social network. A second sub-code is for determining whether the first television program and the second television program are the same. A third sub-code is for determining whether the receiver account and the second receiver account both correspond to a receiver user. A fourth sub-code is for selectively merging the first sharing request and the second sharing request according to determination results of the second sub-code and the third sub-code. Operation variations given in the description associated with the management device 100 are applicable to the non-transitory computer-readable storage medium, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A management method for sharing television program information, comprising:
a) receiving a first sharing request for sharing a first television program with a first receiver account in a first social network, and a second sharing request for sharing a second television program with a second receiver account in a second social network;
b) determining whether the first television program and the second television program are the same;
c) determining whether the first receiver account and the second receiver account both correspond to a receiving user; and
d) selectively merging the first sharing request and the second sharing request according to a determination result of whether the first television program and the second television program are the same, and a determination result of whether the first receiver account and the second receiver account both correspond to the receiving user.

2. The management method according to claim 1, wherein step (d) comprises:
merging the first sharing request and the second sharing request into a merged sharing request according to the determination result indicating that the first television program and the second television program are the same, and the determination result indicating that the first receiver account and the second receiver account both correspond to the receiving user;
the management method further comprising:
transmitting the merged sharing request to a television device of the receiving user, rather than transmitting the first sharing request and the second sharing request to the television device of the receiving user.

3. The management method according to claim 1, wherein the first sharing request is sent from a first transmitter account in the first social network, the second sharing request is sent from a second transmitter account in the second social network; the management method further comprising:
determining whether the first transmitter account and the second transmitter account both correspond to a transmitting user; and
according to a determination result of whether the first transmitter account and the second transmitter account both correspond to the transmitting user, selectively including user information of the first transmitter account and the second transmitter account in the merged sharing request.

4. The management method according to claim 1, wherein step (b) comprises:
determining whether the first television program and the second television program are the same according to one or multiple sets of information including a channel name, a program name, a program time, a program synopsis, a program snapshot and a cast list.

5. A management device for sharing television program information, comprising:
a database, configured to record a plurality of account/user corresponding relationships;
a receiving module, configured to receive a first sharing request for sharing a first television program with a first receiver account in a first social network, and a second sharing request for sharing a second television program with a second receiver account in a second social network;
a first determining module, configured to determine whether the first television program and the second television program are the same;
a second determining module, configured to determine whether the first receiver account and the second receiver account both correspond to a receiving user through looking up the database; and
a merging module, configured to selectively merge the first sharing request and the second sharing request according to determination results of the first determining module and the second determining module.

6. The management device according to claim 5, wherein when the determination results of both the first determining module and the second determining module are affirmative, the merging module merges the first sharing request and the second sharing request to a merged sharing request; the management device only transmitting the merged sharing request to a television device of the receiving user rather than transmitting the first sharing request and the second sharing request to the television device of the receiving user.

7. The management device according to claim 5, wherein the first sharing request is sent from a first transmitter account in the first social network, the second sharing request is sent from a second transmitter account in the second social network; the management device further comprising:
a third determining module, configured to determine whether the first transmitter account and the second transmitter account both correspond to a transmitting user;
wherein, the merging module determines whether to include user information of the first transmitter account and the second transmitter account in the merged sharing request according to a determination result of the third determining module.

8. The management device according to claim 5, wherein the first determining module determines whether the first television program and the second television program are the same according to one or multiple sets of information including a channel name, a program name, a program time, a program synopsis, a program snapshot and a cast list.

9. A non-transitory computer-readable storage medium, for managing a television program information sharing network, storing a code readable and executable by a processor, the code comprising:
a first sub-code, configured to receive a first sharing request for sharing a first television program with a first receiver account in a first social network, and a second sharing request for sharing a second television program with a second receiver account in a second social network;
a second sub-code, configured to determine whether the first television program and the second television program are the same;
a third sub-code, configured to determine whether the first receiver account and the second receiver account both correspond to a receiving user through looking up the database; and
a fourth sub-code, configured to selectively merge the first sharing request and the second sharing request according to determination results of the second sub-code and the third sub-code.

10. The non-transitory computer-readable storage medium according to claim 9, wherein the first sharing request is sent from a first transmitter account in the first social network, the second sharing request is sent from a second transmitter account in the second social network, and the code further comprises:
a fifth sub-code, configured to determine whether the first transmitter account and the second transmitter account both correspond to a transmitting user; and
a sixth sub-code, configured to selectively include user information of the first transmitter account and the second transmitter account in the merged sharing request according to a determination result of whether the first transmitter account and the second transmitter account both correspond to the transmitting user.
